(19) United States
(12) Patent Application Publication
(10) Pub. No.: US 2006/0040197 A1
(43) Pub. Date: Feb. 23, 2006

(54) Toner and fixing method

(75) Inventor: Takahito Kabai, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/157,845

(22) Filed: Jun. 22, 2005

(30) Foreign Application Priority Data
Aug. 20, 2004 (JP) 2004-240956

(51) Int. Cl. G03G 9/087

(52) U.S. Cl. 430/109.4; 430/111.4; 430/124

(57) ABSTRACT

A toner of the present invention includes binder resin and a coloring agent and in a viscoelasticity curve of toner in which the axis of ordinate indicates storage modulus G′ and the axis of abscissa indicates temperature T, temperature Tp giving maximum value G′max of storage modulus G′ is 55 to 65° C. and among calculated values S obtained by the formula indicated below at each temperature, temperature Ts giving minimum value Smin is 50° C. or higher (when Smin is the same at two or more different temperatures, the temperature closest to Tp is set to Ts).
[Formula]

$$S = \frac{{G}_{T2}^{′} - {G}_{40}^{′}}{T2 - 40} - \frac{{G}_{T1}^{′} - {G}_{40}^{′}}{T1 - 40}$$

where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

### CROSS-REFERENCE TO RELATED APPLICATION

This application is based upon and claims the benefit of priority from the prior Japanese Patent Application No. 2004-147807 filed on May 18, 2004, the entire contents of which are incorporated herein by reference.

### FIELD OF THE INVENTION

The present invention relates to a toner and a fixing method used in an electro-photographic apparatus for dry process such as a copier and a printer.

### DESCRIPTION OF THE BACKGROUND

In the electro-photographic apparatus for dry process, when the heating temperature of a fixing device is lowered when fixing a toner image on a sheet of paper, the consumption energy of the electro-photographic apparatus can be reduced greatly, so that fixing at a lower temperature is desired strongly. To reduce the fixing temperature, a method for reducing the melting point of toner is known. However, when the melting point is lowered, toner is apt to condense and the preservation property of toner is reduced often. The reason may be considered that when the melding point of toner is lowered, the glass transition point temperature is also lowered often. Therefore, an art for controlling the melding point of toner and glass transition point temperature to specific temperatures is widely used, though only by adjustment of the melting point and glass transition point temperature, it is difficult to ensure sufficient fixing property at low temperature and preservation property.

It is known that the fixing property of toner is deeply related to the viscoelasticity of toner. A toner melt is a viscoelastitc body indicating properties of both viscosity and elasticity. As indexes for indicating quantitatively the viscoelasticity, there are storage modulus and loss modulus available.

Conventionally, a proposal of using such indexes, quantitatively analyzing the viscoelasticity of toner, setting the storage modulus and loss modulus of toner to fixed values, thereby providing toner which is suitable for fixing at low temperature, causing no offset phenomenon, and ensuing the preservation property is made.

For example, in Japanese Patent Application Publication No. 11-7151, in the viscoelasticity measurement of toner, the storage modulus at 70 to 120° C. and the loss modulus at 130 to 180° C. are set to fixed values, thus toner which has an excellent preservation property, can prevent an offset phenomenon, and can realize fixing at low temperature is proposed.

In the toner described in Japanese Patent Application Publication No. 11-7151, the storage modulus at 70 to 120° C. and the loss modulus at 130 to 180° C. are identified. However, at 70 to 120° C. or 130 to 180° C., the toner is already softened by heating.

According to the experiment and consideration of the inventor, a one affecting the preservation property most greatly is the behavior of toner when the heating temperature thereof is 40° C. to 70° C. or so. Namely, the toner, when the heating temperature thereof reaches about 50° C., starts condensation and when furthermore heating is continued, it becomes melted. The one most affecting the preservation property is the condensation condition during this period and to identify the viscoelasticity of toner at a lower temperature than the temperature described in Japanese Patent Application Publication No. 11-7151 is important in obtaining toner whose fixing property at low temperature and preservation property are superior.

### SUMMARY OF THE INVENTION

An object of the present invention is to identify the viscoelasticity of toner in the neighborhood of the temperature at which the toner starts condensation, thereby provide toner which is fixable at low temperature and is excellent in the preservation property.

The embodiments of the present invention provide toner including binder resin and a coloring agent characterized in that in a viscoelasticity curve of toner in which the axis of ordinate indicates storage modulus G′ and the axis of abscissa indicates temperature T, temperature Tp giving maximum value G′max of storage modulus G′ is 55 to 65° C. and among calculated values S obtained by the formula indicated below at each temperature, temperature Ts giving minimum value Smin is 50° C. or higher (when Smin is the same at two or more different temperatures, the temperature closest to Tp is set to Ts).
[Formula]

$$S = \frac{{G}_{T2}^{′} - {G}_{40}^{′}}{T2 - 40} - \frac{{G}_{T1}^{′} - {G}_{40}^{′}}{T1 - 40}$$

where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

The embodiments of the present invention provide a fixing method using a fixing device composed of a heat roller and a pressure roller pressed to it and the fixing method comprises the steps of preparing a recording member on which a toner image is formed and passing the recording member through a nipping section between the heat roller and the pressure roller pressed to it, wherein the toner for forming a toner image on the recording member has binder resin and a coloring agent and in a viscoelasticity curve of toner in which the axis of ordinate indicates storage modulus G′ and the axis of abscissa indicates temperature T, temperature Tp giving maximum value G′max of storage modulus G′ is 55 to 65° C. and among calculated values S obtained by the formula indicated below at each temperature, temperature Ts giving minimum value Smin is 50° C. or higher. (When Smin is the same at two or more different temperatures, the temperature closest to Tp is set to Ts).
[Formula]

$$S = \frac{{G}_{T2}^{′} - {G}_{40}^{′}}{T2 - 40} - \frac{{G}_{T1}^{′} - {G}_{40}^{′}}{T1 - 40}$$

where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

### BRIEF DESCRIPTION OF THE DRAWINGS

FIG. 1 is a cross sectional view of the essential section of the storage modulus measuring device;

FIG. 2 is a graph showing the relationship between temperature T and storage modulus G′ of toner relating to Embodiment 1;

FIG. 3 is a graph showing the relationship between temperature T and calculated value S of toner relating to Embodiment 1;

FIG. 4 is a graph showing the relationship between temperature T and storage modulus G′ of toner relating to Embodiment 2;

FIG. 5 is a graph showing the relationship between temperature T and calculated value S of toner relating to Embodiment 2;

FIG. 6 is a graph showing the relationship between temperature T and storage modulus G′ of toner relating to Embodiment 3;

FIG. 7 is a graph showing the relationship between temperature T and calculated value S of toner relating to Embodiment 3;

FIG. 8 is a graph showing the relationship between temperature T and storage modulus G′ of toner relating to Embodiment 4;

FIG. 9 is a graph showing the relationship between temperature T and calculated value S of toner relating to Embodiment 4;

FIG. 10 is a table indicating evaluation results of toner relating to the embodiments and comparison examples; and

FIG. 11 is a table indicating evaluation results of Ts and Tp of toner relating to the embodiments and comparison examples.

### DETAILED DESCRIPTION OF THE EMBODIMENTS

Hereinafter, the embodiments of the present invention will be explained. The toner relating to the embodiments is manufactured by the composition and manufacturing method described below.

### Embodiment 1

Firstly, the resin used in this embodiment will be explained.

(1) Manufacture of Amorphous Polyester Resin:

50 parts of BPA-PO (additional matter of propylene oxide of bisphenol A), 20 parts of BPA-EO (additional matter of ethylene oxide of bisphenol A), 14 parts of terephthalic acid, 12 parts of dodecenylsuccinic anhydride, 8 parts of anhydrous trimellitic acid, and 5 parts of dibutyltin oxide are mixed and then are polymerized at 210° C. to 230° C. for eight hours in a container. The container is evacuated to 8 kPa while being decompressed slowly, and then is moreover reacted continuously, thus amorphous polyester resin having a softening point of 110° C. and a glass transition point temperature of 60° C. is obtained.

(2) Manufacture of Crystalline Polyester Resin:

95 parts of 1.4-butanediol, 5 parts of glycerine, 100 parts of fumaric acid, and 5 parts of hydroquinone are mixed, polymerized at 150° C. to 170° C. for five hours in a container, then are raised to 200° C., and are reacted for one hour while being decompressed slowly. Thereafter, the container is evacuated to 8 kPa, is moreover reacted for one hour, thus crystalline polyester resin having a melting point of 120° C. is obtained.

The crystalline polyester resin contains a crystalline part in itself and the degree of crystallinity is generally 50% or less. The crystalline polyester resin, when heated, has an area where the viscosity is reduced suddenly, while the amorphous polyester resin, as the temperature rises, has a wide temperature area where the viscosity is reduced slowly, so that the amorphous polyester resin is distinguished from the crystalline polyester resin by it.

Next, the manufacturing method of toner will be explained. Firstly, the following materials are prepared.

Amorphous polyester resin: 83 parts by weight,

Carbon black (MA-100 by Mitsubishi Kagaku): 4 parts by weight,

Rice wax (SS-1 by Boso Yushi): 3 parts by weight,

Zirconium complex (TN105 by Hodogaya Kagaku Kogyo): 1 part by weight, and

Crystalline polyester resin: 9 parts by weight.

The aforementioned materials are mixed by a mixer, then are fused and mixed by a biaxial continuous mixer, is ground by a collision type grinder, is classified by an air flow classifier, thus toner particles 8 μm in diameter are obtained. With the toner particles, two parts by weight of silica (R-972 by Nihon Aerosil Co.) is mixed by a Henschel mixer (by Mitsui Kozan, Ltd.) and final toner is obtained.

8 parts by weight of the toner and 92 parts by weight of a ferrite carrier are mixed to produce a 2-component developer. The 2-component developer is used as a developer for a full-color copier by Toshiba Tech, Ltd., and the fixing temperature of the fixing unit is changed to various values, and toner is fixed on sheets of paper.

As evaluation of toner, the existence of an occurrence of an offset phenomenon when it is fixed is confirmed visually, thus a lowest fixing temperature for performing satisfactory fixing is checked, and by the lowest fixing temperature, the suitability thereof to the fixing property at low temperature is judged by the lowest fixing temperature. A lowest fixing temperature of 160° C. or lower is judged as satisfactory.

Further, to test the preservation property of toner, toner of 20 g is put into a bottle of 100 cc, and the bottle is left at 55° C. for 8 hours as it is, and the toner is put and passed through a sieve of a 250 μm mesh, and then the residual amount of toner on the sieve is measured. A residual amount of toner of 5 g or less is judged as satisfactory.

As a result, it is found that the lowest fixing temperature of toner in this embodiment is 145° C. and the toner is suitable for fixing at low temperature. On the other hand, the preservation property is satisfactory because the residual amount is 2 g.

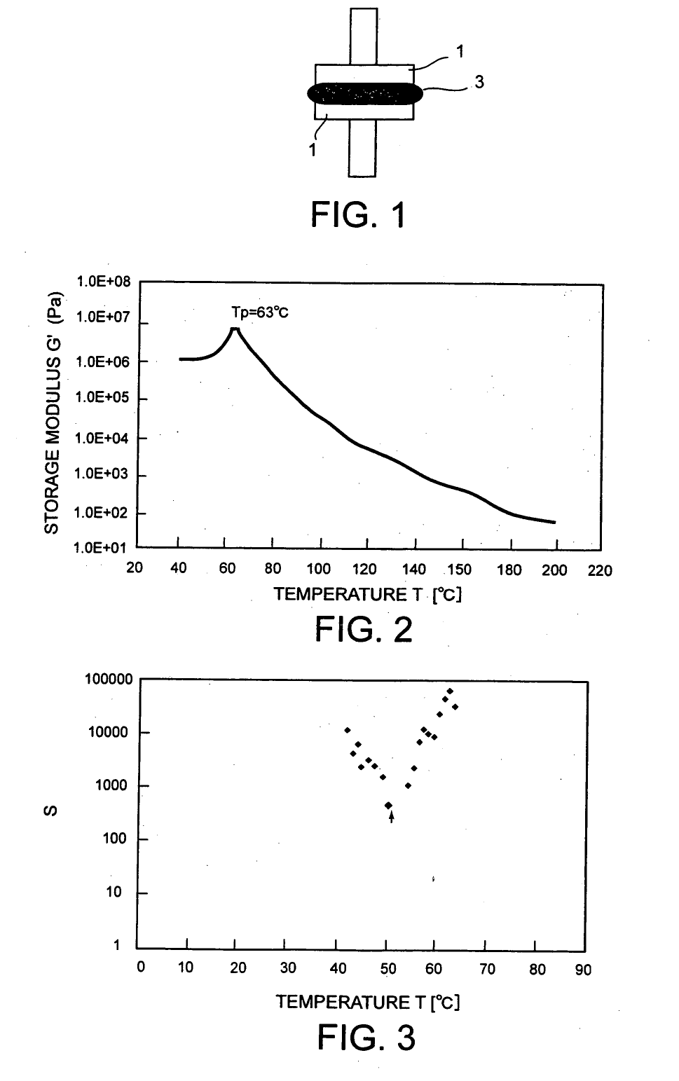

Further, the storage modulus of toner is measured by the following method. Firstly, the measurement principle will be explained by referring to FIG. 1.

Toner 3 which is a sample to be measured is clamped by parallel plates 1 composed two plates arranged opposite to each other in parallel. And, in this condition, parallel plate 1 on one side is moved so as to give a strain expressed by a sine wave at a fixed frequency to toner 3. Against this strain, stress to return is generated in the toner late by a fixed time. This delay and stress are measured and the storage modulus which can be obtained by the known predetermined formula is calculated.

Here, the storage modulus will be explained.

The viscoelastic body is referred to as a substance indicating an intermediate state between an ideal elastic body and a pure viscous body. The ideal elastic body is referred to as a one which, when it is applied with external force and is deformed, generates stress in proportion to the deformation and when the external force is removed, loses the deformation and is returned to its original state. On the other hand, the pure viscous body is referred to as a one which, when it is applied with external force and is deformed, generates stress in proportion to the deformation speed and when the external force is removed, reduces the stress to zero, keeps the deformation state as it is, and is not returned to its original state. And, a one existing in the intermediate state of the two is a viscoelastic body.

When a sine-wave strain is applied to such a viscoelastic boy, the stress also responds to it at the same frequency, though a potential difference is generated between the stress and the strain due to viscosity. The storage modulus expresses the size of the stress component at the same potential when the sine-wave strain is added and can be obtained by the known predetermined calculation formula.

The actual measurement conditions are as indicated below.

Measuring instrument: ARES (by Rheometric Co.)

Measurement mode: Measurement of temperature distribution

Measurement temperature range: 40° C. to 200° C.

Temperature rise rate: 3° C./min.

Measurement frequency: 10 rad/s

Toner is pressured and molded to a circular sample with a diameter of 25 mm and a thickness of 2 to 3 mm. Next, the toner is set in a parallel-plate with a diameter of 25 mm, is slowly raised in temperature within the temperature range of 40° C. to 200° C., and is applied with a sine-wave vibration at a predetermine frequency. The stress at that time is measured and the storage modulus is obtained. The axis of abscissa is set to temperature T, and the axis of ordinate is set to storage modulus G′, and a viscoelastic curve is prepared.

FIG. 2 shows the relationship between measurement temperature T and storage modulus G′ of toner relating to Embodiment 1.

As shown in FIG. 2, in the toner relating to Embodiment 1 aforementioned, as the heating temperature rises, storage modulus G′ also rises and a maximum peak value is recorded at 63° C. After recording of the maximum peak value, storage modulus G′ reduces slowly.

Further, as an index indicating changes in storage modulus G′, value S obtained by the formula indicated below is calculated at a temperature at several points. Calculated results are shown in FIG. 3.
[Formula]

$$S = \frac{{G}_{T2}^{′} - {G}_{40}^{′}}{T2 - 40} - \frac{{G}_{T1}^{′} - {G}_{40}^{′}}{T1 - 40}$$

where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

As shown in FIG. 3, calculated value S is, as a whole, between 40° C. and 50° C. and as the temperature rises, is reduced. S at 50° C. is a minimum value and thereafter, calculated value S is increased as the temperature rises.

Calculated value S, as shown in FIG. 2, at a measurement temperature at which storage modulus G′ is changed greatly, appears as a small value. Therefore, at the minimum value of calculated value S, it may be considered that storage modulus G′ is changed suddenly. Actually, as shown in FIG. 2, at 50° C. where calculated value S records a minimum value, storage modulus G′ is increased suddenly.

Actually, at two or more different temperatures, calculated values S may be the same, though in this case, it may be considered that a temperature closer to temperature Tp giving maximum value G′max of storage modulus is point Ts where storage modulus G′ is changed suddenly.

As shown also by the embodiments and comparison examples described below, the inventor, from results of various experiments, came to consider that the behavior of toner in the initial measurement at a heating temperature of 40° C. to 70° C. or so in measurement of the viscoelasticity of toner most affects on the fixing property at low temperature and preservation property.

In the initial measurement, firstly, as the temperature rises, the sample starts condensation, and the tendency as an elastic body gets stronger at first, and storage modulus G′ is increased. Further, there exists temperature Ts at which storage modulus G′ is increased suddenly and at the time of arrival at this temperature, it may be considered that the toner suddenly starts condensation. Therefore, as temperature Ts at which storage modulus G′ starts a sudden rise is increased, the condensation start temperature of toner is also increased, and the preservation property may be considered to improve. Namely, as temperature Ts giving calculated value S is increased, good results can be obtained in the preservation property.

When storage modulus G′ starts a sudden temperature rise and then the toner is heated additionally, a peak value appears in storage modulus G′. When the toner temperature is raised moreover, in correspondence with softening and fusion of the toner, the tendency as a viscous body gets stronger and storage modulus G′ becomes smaller. Namely, the peak value of storage modulus G′ is a value when the tendency of the condensed toner as a viscous body starts becoming stronger and it may be the to be a temperature at which the toner particles reach the most closely adhered state.

When the image after the toner is fixed is observed with a microscope, although the image is integral, the shape of toner particles can be confirmed. The reason may be considered to be that the toner is not fused perfectly at the time of fixing and there are a considerable number of parts which are thermally condensed strongly.

Therefore, when storage modulus G′ is at a peak value, it may be considered that the toner is close to the thermal condensation state at the time of fixing and it is important in providing low-temperature fixing toner to make the temperature as low as possible at which storage modulus G′ gives a peak value.

From the aforementioned, the sudden rise start temperature of the storage modulus and the temperature at the peak of the storage modulus are appropriately set, thus compatibility of the low temperature fixing property of toner with the preservation property thereof can be realized.

In the toner relating Embodiment 1, Tp is 63° C., and Ts is 50° C., and the low temperature fixing property of toner and the preservation property thereof show good results.

### Embodiment 2

Amorphous polyester resin: 90 parts by weight,

Carbon black (MA-100 by Mitsubishi Kagaku): 4 parts by weight,

Rice wax (SS-1 by Boso Yushi): 3 parts by weight,

Zirconium complex (TN105 by Hodogaya Kagaku Kogyo): 1 part by weight, and

Crystalline polyester resin: 2 parts by weight.

Similarly to Embodiment 1, the aforementioned materials are mixed by the mixer, then are fused and mixed by the biaxial continuous mixer, is ground by the collision type grinder, is classified by the air flow classifier, thus toner particles 8 μm in diameter are obtained. To the toner particles, two parts by weight of the same silica as that of Embodiment 1 is added and the toner relating to Embodiment 2 is obtained.

By the same method as that of Embodiment 1, the toner relating to Embodiment 2 is evaluated, and the lowest fixing temperature is 148° C., and the preservation property test obtains good results such as a residual amount of 1 g.

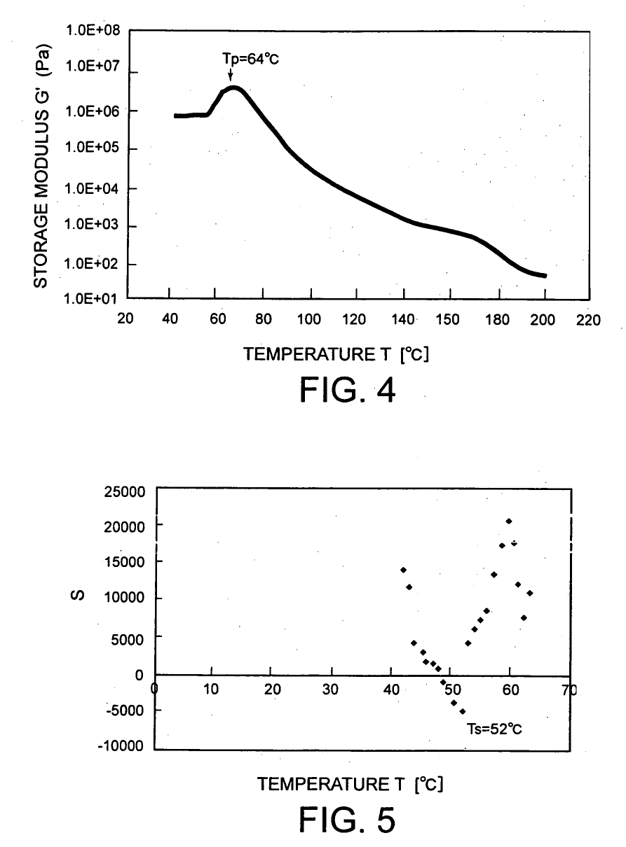

For the toner relating to Embodiment 2, in the same way as with Embodiment 1, storage modulus G′ is measured and the obtained results are shown in FIG. 4. Further, the changes in calculated value S are shown in FIG. 5.

Temperature Tp for giving storage modulus G′max is 64° C. and temperature Ts for giving the minimum value of calculated value S is 52° C.

Next, the same material as that of Embodiments 1 and 2 is used, and the toner composition is changed as indicated below, and by the same method as that of the embodiments, toner relating to Comparison examples 1 and 2 is manufactured.

### Comparison Example 1

Amorphous polyester resin: 64 parts by weight,

Carbon black: 4 parts by weight,

Rice wax: 3 parts by weight,

Zirconium complex: 1 part by weight, and

Crystalline polyester resin: 28 parts by weight.

With the toner particles obtained, in the same way as with Embodiment 1, silica is mixed as an external additive and final toner is obtained.

### Comparison Example 2

Amorphous polyester resin: 92 parts by weight,

Carbon black: 4 parts by weight,

Rice wax: 3 parts by weight,

Zirconium complex: 1 part by weight, and

Crystalline polyester resin: 0 parts by weight.

With the toner particles obtained, in the same way as with Embodiment 1, silica is mixed as an external additive and final toner is obtained.

For the toner relating to Comparison examples 1 and 2 aforementioned, in the same way as with Embodiment 1, the lowest fixing temperature is measured and the preservation property test is executed. The test results are shown in FIG. 10.

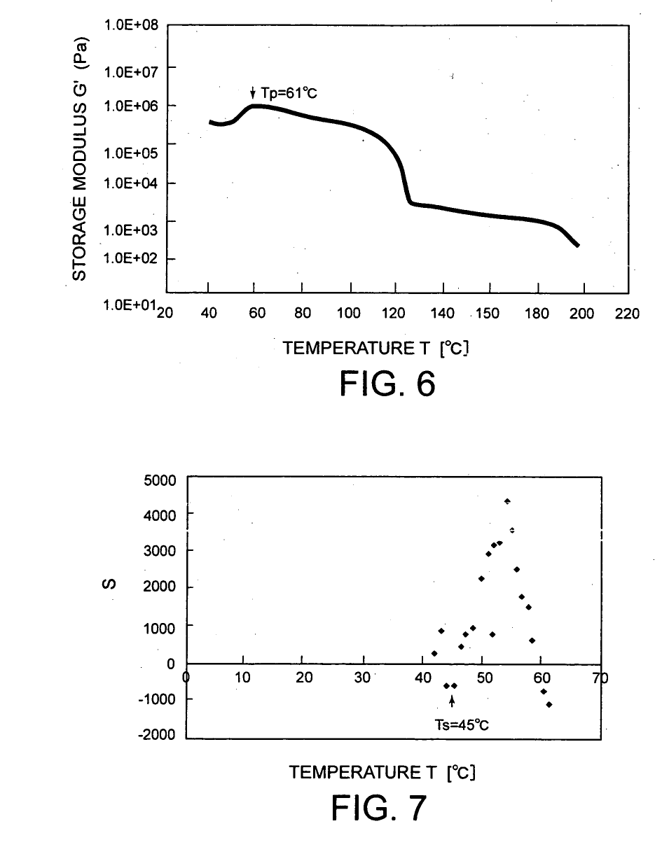

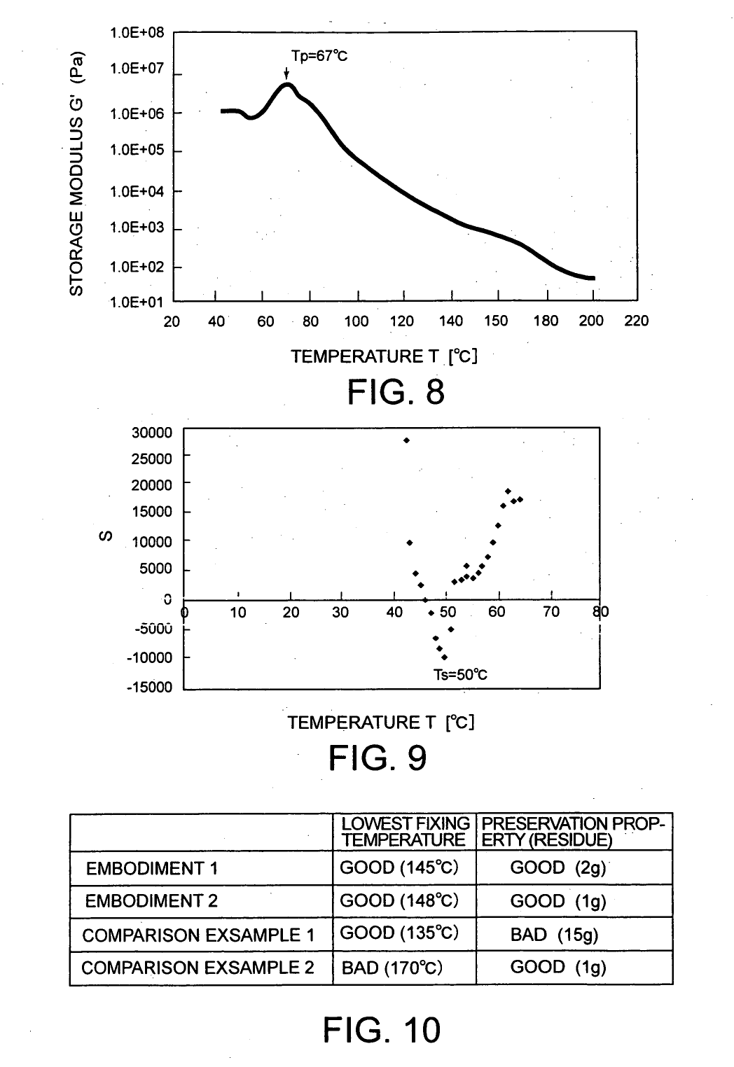

The measured results of storage modulus G′ of the toner relating to Comparison example 1 are shown in FIG. 6 and the measured results of calculated value S are shown in FIG. 7. Similarly, the measured results of storage modulus G′ of the toner relating to Comparison example 2 are shown in FIG. 8 and the measured results of calculated value S are shown in FIG. 9.

Temperature Tp for giving storage modulus G′max of the toner relating to Comparison example 1 is 61° C. and temperature Ts for giving the minimum value of calculated value S is 45° C. On the other hand, temperature Tp for giving storage modulus G′max of the toner relating to Comparison example 2 is 67° C. and temperature Ts for giving the minimum value of calculated value S is 50° C.

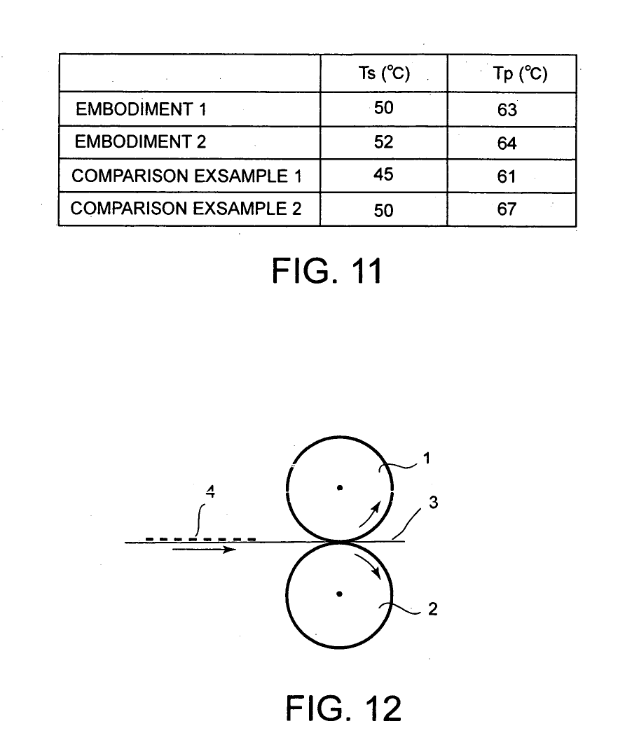

Tp and Ts of the toner relating to Embodiments 1 and 2 and Comparison examples 1 and 2 are all shown FIG. 11.

As shown by the embodiments and comparison examples, in Comparison example 1 in which temperature Ts for giving the minimum value of calculated value S is lower than 50° C., the toner is apt to condense and the results of the preservation property test are not good. On the other hand, temperature Tp for giving storage modulus G′max of the toner relating to Comparison example 2 is 67° C. and the lowest fixing temperature is 170° C., so that it is not suitable for the low temperature fixing.

From the aforementioned results, when the viscoelasticity characteristics of toner, in a viscoelasticity curve of toner in which the axis of ordinate indicates storage modulus G′ and the axis of abscissa indicates temperature T, are such that temperature Tp giving maximum value G′max of storage modulus G′ is 55 to 65° C. and temperature Ts giving minimum value G′min of the values expressed by the formula indicated below is 50° C. or higher, it is found that superior results are obtained in the low temperature fixing property and preservation property.

Further, to obtain preferable results, temperature Ts and temperature Tp approach each other and it is desirable to set the difference between temperature Ts and temperature Tp between 5° C. and 15° C.

According to this embodiment, it is found that toner excellent in both low temperature fixing property and preservation property can be provided.

As a material used in the present invention, the present invention is not limited to the ones described in the aforementioned embodiments and various materials can be used.

The crystalline polyester resin is obtained using, for example, a monomer containing a carboxylic acid component composed of a bivalent or higher multivalent carboxylic acid compound and an alcohol component composed of bivalent or higher multivalent alcohol.

As an acid component, a fumaric acid, a maleic acid, a citraconic acid, an itaconic acid, a glutaconic acid, a phthalic acid, an isophthalic acid, a terephthalic acid, a cyclohexanedicarboxylic acid, a succinic acid, an adipic acid, a sebacic acid, and an azelaic acid can be used.

As an alcohol component, ethylene glycol, propylene glycol, 1.4-butanediol, 1.3-butanediol, 1.5-pentanediol, 1.6-hexanediol, neopentyl glycol, glycerine, trimethylolethane, and trimethylolpropane can be used.

Particularly, a crystalline compound in a general wax state obtained by condensing and polymerizing an alcohol component containing an alkyl or alkenyl radical of a carbon number of 16 or more, or 80 or more mol % of diol of a carbon number of 2 to 6 and a carboxylic acid component containing 80% or more mol % of a fumaric acid is preferable. With respect to these components, one kind or two or more kinds may be mixed and used.

As wax, low molecular weight polyethylene, low molecular weight polypropylene, polyolefin copolymer, polyolefin wax, microcrystalline wax, paraffin wax, carnauba wax, and rice wax can be used.

As a coloring agent, carbon black and organic or inorganic pigment or dye can be used.

As carbon black, acetylene black, furnace black, thermal black, channel black, and ketchen black can be used.

Further, as pigment, for example, first yellow G, benzidine yellow, indofast orange, irgazine red, carmen FB, permanent bordeaux FRR, pigment orange R, lithol red 2G, lake red C, rhodamine FB, rhodamine B lake, phthalocyanine blue, pigment blue, brilliant green B, phthalocyanine green, and quinacridone can be used independently or by mixing.

As a charge control agent, for example, when the coloring agent is carbon black or an achromatic pigment or dye, a metallic azoic compound containing at least one kind selected from the group of complexes and complex salts of iron, cobalt, and chromium can be used preferably. Further, when the coloring agent is a chromatic pigment or dye, a metallic salicylic acid derivative compound containing at least one kind selected from the group of complexes and complex salts of zirconium, zinc, chromium, and boron can be used.

To adjust the flowability and chargeability, toner particles can be mixed with inorganic minute particles of 0.2 to 3 wt %. As such inorganic minute particles, silica, titania, alumina, titanic acid strontium, and tin oxide can be used independently or by mixing of two or more kinds.

Inorganic minute particles subject to the surface treatment by a hydrophobic agent are preferably used from the viewpoint of improvement of the environment stability. Further, to toner particles, in addition to this inorganic oxide, minute particles of resin with a diameter of 1 μm or less can be added for improvement of the cleaning property.

In the embodiment aforementioned, by using crystalline polyester resin, the sudden rise start temperature of the storage modulus and the temperature at the peak are adjusted. However, in addition to it, by design of the molecular weight of wax and resin, these temperatures can be adjusted.

FIG. 12 shows the fixing device for fixing a toner image formed on a recording medium using the toner of the present invention.

The fixing device has heat roller 1 as a heat rotator and onto the lower side of heat roller 1, pressure roller 2 as a pressure rotator is pressed.

Pressure roller 2 is pressed to heat roller 1 by a pressure spring (not drawn) and is maintained to have a fixed nipping width.

Heat roller 1 is driven to rotate in the direction of the arrow by a drive motor (not drawn) and pressure roller 2 is driven to rotate in the direction of the arrow in correspondence with the concerned rotation. Sheet of paper 3 as a recording member passes through the fixing point which is a pressed part (nipping section) between heat roller 1 and pressure roller 2, thus toner image 4 on sheet of paper 3 is fused, pressed, and fixed.

On sheet of paper 3, using the toner of the present invention aforementioned, toner image 4 is formed. The toner used to form toner image 4 has the characteristics indicated below.

Namely, the toner includes binder resin and a coloring agent and in a viscoelasticity curve of toner in which the axis of ordinate indicates storage modulus G′ and the axis of abscissa indicates temperature T, temperature Tp giving maximum value G′max of storage modulus G′ is 55 to 65° C. and among calculated values S obtained by the formula indicated below at each temperature, temperature Ts giving minimum value Smin is 50° C. or higher (when Smin is the same at two or more different temperatures, the temperature closest to Tp is set to Ts).
[Formula]

$$S = \frac{{G}_{T2}^{′} - {G}_{40}^{′}}{T2 - 40} - \frac{{G}_{T1}^{′} - {G}_{40}^{′}}{T1 - 40}$$

where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

According to the present invention, toner which can be fixed at low temperature and ensures an excellent preservation property can be provided.

What is claimed is:

1. A toner comprising binder resin and a coloring agent, wherein, in a viscoelasticity curve of the toner in which an axis of ordinate indicates storage modulus G′ and an axis of abscissa indicates temperature T, temperature Tp giving maximum value G′max of the storage modulus G′ is 55 to 65° C. and among calculated values S obtained by a formula indicated below at each temperature, temperature Ts giving minimum value Smin is 50° C. or higher (when Smin is the same at two or more different temperatures, a temperature closest to Tp is set to Ts).
[Formula]
$$S = \frac{{G}_{T2}^{′} - {G}_{40}^{′}}{T2 - 40} - \frac{{G}_{T1}^{′} - {G}_{40}^{′}}{T1 - 40}$$
where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

2. The toner according to claim 1, wherein the binder resin contains crystalline polyester and the coloring agent is contained in the binder resin.

3. The toner according to claim 2, wherein the crystalline polyester resin is contained by 1 to 20 parts by weight in the binder resin.

4. The toner according to claim 1, wherein a difference between the temperature Tp and the temperature Ts is 5 to 15° C.

5. A fixing method using a fixing device comprising a heat roller and a pressure roller pressed to the heat roller, comprising:
preparing a recording medium on which a toner image is formed; and
passing the recording member through a nipping section between the heat roller and the pressure roller pressed to the heat roller,
wherein a toner for forming a toner image on the recording member has binder resin and a coloring agent and in a viscoelasticity curve of the toner in which an axis of ordinate indicates storage modulus G′ and an axis of abscissa indicates temperature T, temperature Tp giving maximum value G′max of the storage modulus G′ is 55 to 65° C. and among calculated values S obtained by a formula indicated below at each temperature, temperature Ts giving minimum value Smin is 50° C. or higher (when Smin is the same at two or more different temperatures, a temperature closest to Tp is set to Ts).
[Formula]
$$S = \frac{{G}_{T2}^{′} - {G}_{40}^{′}}{T2 - 40} - \frac{{G}_{T1}^{′} - {G}_{40}^{′}}{T1 - 40}$$
where
T1=optional measurement temperature (° C.),
T2=next measurement temperature of T1, T1<T2 (° C.),
G′₄₀=storage modulus of toner measured at 40° C. (Pa),
G′_{T1}=value of G′ measured at T1° C. (Pa), and
G′_{T2}=value of G′ measured at T2° C. (Pa).

6. The fixing method according to claim 5, wherein the binder resin of the toner contains crystalline polyester and the coloring agent is contained in the binder resin.

7. The fixing method according to claim 6, wherein the crystalline polyester resin is contained by 1 to 20 parts by weight in the binder resin.

8. The fixing method according to claim 5, wherein a difference between the temperature Tp and the temperature Ts is 5 to 15° C.
